(19) United States
(12) Patent Application Publication
(10) Pub. No.: US 2007/0083533 A1
(43) Pub. Date: Apr. 12, 2007

(54) System and method for designing web sites that perform like conventional software applications

(75) Inventors: Aram Mirkazemi, Llndisfarne (AU); Shahram Bosharati, Kingston Beach (AU)

Correspondence Address: William C. Milks, III;RUSSO & HALE LLP, 401 Florence Street, Palo Alto, CA, 94301, US

(73) Assignee: Morfik Technology Pty. Ltd.

(21) Appl. No.: 11/546,175

(22) Filed: Oct. 10, 2006

Related U.S. Application Data
(60) Provisional application No. 60/725,249, filed on Oct. 11, 2005.

(51) Int. Cl. G06F 7/00

(52) U.S. Cl. 707/100

(57) ABSTRACT

A system and method to create web sites and web applications that address the significant limitation of unnecessary and artificial page refreshes, which are inherent in most current web solutions, by moving away from the paradigm where a user navigates from one page to another. Rather, they are based on an architecture that morphs the user interface from one state to another, thereby performing more like desktop applications. This system and method are based on a topological map that exhibits self-similar or fractal characteristics, consisting of a hierarchy of heterogeneous nodes where each parent node is an identical construct that comprises repeatable bands.

### CROSS-REFERENCE TO RELATED APPLICATION

This application relates to U.S. Provisional Patent Application No. 60/725,249 filed on Oct. 11, 2005 entitled SYSTEM AND METHOD FOR DESIGNING WEB SITES THAT PERFORM LIKE CONVENTIONAL SOFTWARE APPLICATIONS.

### BACKGROUND OF THE INVENTION

1. Field of the Invention

The present invention relates generally to a system and method for computer programming of web sites and, more particularly, to a system and method to enable a computer programmer to program web sites that perform like conventional software applications. In accordance with various embodiments of the present invention, a system and method are provided to enable developers of web sites to provide an architecture whose context persists throughout an entire user session and whose layout, presentation, logic, and content only partially or incrementally change at run-time in response to a user's inputs and interactions.

2. Description of the Prior Art

By way of background, there is a growing number of web technologies and methodologies that help developers of web sites create experiences that are much richer than are offered by traditional static hypertext markup language (HTML) web sites. However, a major obstacle in creating a web site or web application, that runs more like a desktop application, is the page refresh limitation, namely, if an aspect of a web page has to be altered, no matter how small the alteration is and/or if the user's session management has to be updated, then the entire page has to be refreshed. This is mainly due to the fact that these static HTML web sites do not consist of spatially connected pages. The concept of spatially connected pages is related to partitioning or modularization, where partitioning is the act of dividing the physically viewable page into smaller areas, each of which is designed separately; and modularization is the process of combining numerous simple components to form a complex web page.

The introduction of framesets and more recently inline frames (“iframes”) has helped alleviate some of page refresh disadvantage. For example, a web site may have an iframe embedded in a section of the screen, which displays local weather details, stock quotes, etc. In virtually all these instances, the developer utilizes the iframe in a manner in which it is expected that there will be virtually no interaction between what is contained in the main page/frame and what is contained in the iframe. This may be likened to the “picture-in-picture” effect available on many television sets; that is, within a small section of the television screen the user is able to view a program on a different channel. Therefore, multiple channels can be viewed/displayed simultaneously. However, this is only at the presentation level. At the logical, conceptual, or broadcast level, they are conceptually logically distinct, independent, and non-interacting channels.

There are two significant problems with the existing techniques that use iframes. The first is that to reference another iframe requires explicitly knowing the presentation hierarchy of the two frames. For example, code in one frame, say iframe1, that initiates some action in another sibling iframe, say iframe2, requires code such as:
window.parent.frame2.someElement

If the two iframes are not sibling nodes, then the code is more complex, and the developer not only has to know the exact relationship between the two iframes, but also the names and relationship of all intermediary iframes, for example:

window.parent.parent.Frames[3].LeftFrame

.FooterFrame.frame2.someElement

One of the more significant problems with the iframe technique is that if one chooses to move iframe1 to a different place in the hierarchy of the iframes, then all the underlying logic where reference is made to iframe2 must also be explicitly altered. Another problem with iframes is that the browser context when moving from one iframe to another is not maintained by current systems.

Ajax (Asynchronous Javascript and XML) is a term describing a web development technique for creating interactive web applications using a combination of:
HTML (or XHTML) and CSS;
The Document Object Model (DOM) manipulated through Javascript to dynamically display and interact with the information presented; and
The XMLHttpRequest object to exchange data asynchronously with a web server.

Web pages that directly manipulate a browser's DOM allow updating at an even finer resolution. Many of the new Ajax-powered web sites utilize this technique.

These Ajax-based web techniques which, by virtue of their (i) asynchronous nature at run-time, (ii) their client-side Javascript engine (typically known as an “Ajax-engine”), and (iii) the direct modification of the DOM, allow all parts of the web technique to share the same browser context and significantly minimize page refreshes. However, a major drawback of Ajax-based web techniques is that there is not a solid foundation, architecture, or methodology for designing web sites. Further, there are no professional-grade visual programming environments to design them.

Inherent in the traditional page-centric design methodology is that the browser assumes minimal intelligence not far from that of a dumb terminal, and relies almost entirely on external sources for providing the required intelligence. There have been two main approaches, those that channel intelligence to the browser by running stand-alone embedded executables within the browser (for example, Java Applet, ActiveX, Flash controls, etc.) and those that increase the perceived intelligence of the browser by relying on complex server-side processing (for example, ASP, PHP, ISAPI, etc.).

The former category, although offering more of a desktop experience, fail to create a genuine web site experience and merely exploit the ubiquity of the browser, rather than its power. For the sake of clarity, these web applications are henceforth referred to as browser-compatible approaches rather than browser-based approaches.

Furthermore, the latter category, although they run natively in the browser and are therefore browser-based, do not offer a complete solution to the page-refresh limitation, by virtue of their continued emphasis on a page-centric architecture. These browser-based approaches merely consist of a hyperlinked collection of nodes (web pages) that are spatially and computationally unrelated at design—and run-time. Even the more recent Ajax-based or “Ajax-like” web approaches which, by virtue of their asynchronous nature, and Javascript engine, eliminate much of the page-centric nature at run-time, they lack a solid foundation, architecture, or methodology for designing web solutions.

Additionally, there exist various database technologies, including Rapid Application Development Database Applications such as Microsoft Access. These database applications include various features, for example, the use of visual programming and report generation which includes the ability to sort and group records. However, the output cannot be natively interpreted by a web browser. Furthermore, the user cannot interact with the output through the programming logic that is stored, accesses, and alters through the browser's DOM.

In summary, the major obstacle in creating a web site or web application that runs more like a desktop application is the page refresh limitation. Therefore, the known prior art has numerous disadvantages. The present invention is directed as a solution which allows developers to employ a solid modularized methodology to create Ajax-based web scalable solutions via a professional-grade visual programming environment to program web sites that perform like conventional software applications. The various embodiments of the present invention provide many advantages over conventional web site programming approaches.

### SUMMARY OF THE INVENTION

In accordance with the various embodiments of the system and method of the present invention, a web site developer is provided with the power to create web solutions that eliminate the page refresh limitation at the architectural level, thereby allowing them to run more like desktop applications. The various embodiments of the present invention model the web solution on a topological map that consists of a hierarchy of heterogeneous nodes, each of which is spatially and computationally related, and is maintained both at design-time and run-time. These hierarchical nodes, which represent individual, dynamic, and interactive components that run natively in the web browser, are generated incrementally, independently, and on-demand.

The various embodiments of the system and method of the present invention overcome the page refresh limitation that is the major obstacle in creating a web site or web application that runs more like a desktop application. The system and method in accordance with the various embodiments of the present invention enable web design that is fundamentally different from currently existing technologies and methodologies. The system and method of the present invention provide a web solution that uses a “pageless” paradigm that delivers both a full web site and a desktop application experience at once referred to for convenience as an “xApp.” This very broad category includes all experiences that are presented to the user through the web. This includes the traditional web sites, the recent Ajax-powered web sites, as well as the specialized executables that are often termed “web applications” or “rich internet applications” that run within the browser such as Java Applets, ActiveX, Flash controls, etc. This “pageless” development paradigm, whereby a web solution can be designed in a fully modularized fashion, along with the intelligence that is added to the client, provides a level of richness to the user's web experience that has only been present via desktop applications.

In contrast to the known prior art, the architecture of an xApp in accordance with the various embodiments of the present invention is based on a topological map that consists of a hierarchy of heterogeneous nodes which are spatially and computationally related at design-time, as well as run-time, and whose parent nodes all exhibit a self-similar structure. In terms of design methodology, the xApp is created in a fully modularized manner via a Visual Programming Environment whose hierarchy at design-time is fully maintained at run-time. In terms of implementation, the xApp is comprised of a single entity whose context persists throughout the entire user's session and whose layout, presentation, logic, and content only partially or incrementally change at run-time in response to a user's inputs and interactions. This not only allows users to navigate in a manner that has less disjointed interruptions and delays, and more seamless interaction, but also eliminates an entire set of complex, counter-intuitive methods such as “state-tracking” that are common to page-centric web approaches.

Various embodiments of the system and method in accordance with the present invention comprise features that are similar to those found in Rapid Application Development Database Applications such as Microsoft Access, for example, the use of visual programming and report generation which includes the ability to sort and group records. However, the defining difference is that the system and method in accordance with the various embodiments of the system and method of the present invention are designed from the outset to create output that can be natively interpreted by a web browser. Furthermore, users interact with the output through the programming logic that is stored, accesses, and alters through the browser's DOM, of which there is no equivalent in Microsoft Access.

The foregoing and other objects, features, and advantages of the present invention will become more readily apparent from the following detailed description of various embodiments, which proceeds with reference to the accompanying drawing.

### BRIEF DESCRIPTION OF THE DRAWING

The various embodiments of the present invention will be described in conjunction with the accompanying figures of the drawing to facilitate an understanding of the present invention. In the figures, like reference numerals refer to like elements. In the drawing:

FIG. 1 shows the Project Manager for the Visual Programming Environment used to create the xApp in accordance with the various embodiments of the system and method of the present invention in a fully modularized manner and whose hierarchy at design-time is fully maintained at run-time;

FIG. 2 illustrates a sorted set of database-driven bands at design-time;

FIG. 3 illustrates a sorted set of database-driven bands at run-time;

FIG. 4 illustrates a grouped set of database-driven bands at design-time;

FIG. 5 illustrates a grouped set of database-driven bands at run-time;

FIG. 6 illustrates PDF reports implemented via bandsets at run-time;

FIG. 7 illustrates single-view screens implemented via bandsets;

FIG. 8 illustrates event-handling in a repeatable band;

FIG. 9 illustrates using subforms to define spatial regions and child nodes for other forms at design-time;

FIG. 10 illustrates hierarchical nodes via nested subforms at design-time;

FIG. 11 illustrates hierarchical nodes via nested subforms at run-time;

FIG. 12 illustrates displaying multiple instances of the same form simultaneously at design-time;

FIG. 13 illustrates displaying multiple instances of the same form simultaneously at run-time; and

FIG. 14 is a diagram illustrating the hierarchy of the xApp described in conjunction with the embodiment described in conjunction with FIGS. 9, 10, and 11.

### DETAILED DESCRIPTION OF THE PREFERRED EMBODIMENTS

The present invention is particularly applicable to a computer-implemented software-based system and method to code web sites that perform like conventional software applications, and it is in this context that the various embodiments of the present invention will be described. The examples included are based on a preferred embodiment which includes a Visual Programming Environment to create Ajax-based web scalable solutions.

In terms of design methodology, an xApp is created in a fully modularized manner via a Visual Programming Environment, as shown in FIG. 1. The hierarchy at design-time is fully maintained at run-time.

Insofar as the design-time process is concerned, in accordance with the various embodiments of the system and method of the present invention, the architecture of the xApp is characterized by, and built upon, a topological map. This map consists of a hierarchy of heterogeneous nodes, each of which is spatially and computationally related, and can be incrementally and independently displayed, accessed, and/or altered at run-time. Additionally, parent nodes are all created from an identical construct and contribute to the web site or web application's fractal or self-similar nature.

The hierarchical nodes are preferably designed using the Visual Programming Environment. See FIGS. 1, 2, 4, 6, 8, 9, 10, and 12. These hierarchical nodes represent individual dynamic and interactive components of the xApp and are then generated on-demand and collaged together in a fully modular fashion.

Considered in more detail, the topological map consists of a hierarchy of heterogeneous nodes. A feature of the various embodiments of the system and method in accordance with the present invention is the use of what are referred to as “bands.” This terminology is based on a similar concept that is commonly known and used in association with paper report generators such as Microsoft Access and Business Object's Crystal Reports. A “band” may be defined as “a construct that defines the layout, presentation, and logic of a component of an xApp that is displayed in a rectangular region of a browser window.” In addition, a “bandset” may be defined as “a consecutively ordered set of bands with sorting and grouping capabilities.”

In the context of interactive and database-driven web sites, the following describes various significant features of bands. First, bands allow a user full web interactivity. A band may contain interactive controls that allow the user to select options, enter data, link to other parts of the web site, view multimedia files, etc.

Second, the bands are designed to run natively in web browsers. These bands are not executables, nor do they require plug-ins of any kind.

Third, absolute positioning of controls within a band is provided. The “form” controls within a band are preferably defined in absolute terms according to the vertical and horizontal distances from the top-left hand corner of the band or containing control such as “container” or “subform” which will be described in more detail later. The position of each control within a band may be independent of the position of all other controls in the band.

Fourth, bands may contain further bandsets inside them. Through the use of a specialized control called a “subform,” a band may contain further bands. This characteristic is a defining aspect of an xApp that allows it to be considered hierarchical.

Various significant features of a bandset include the following. First, the positioning of each band within the bandset is based solely on the position and size of the previous band, and this positioning is performed purely using the power of the browser. That is, if one particular band increases in size, then all other bands within the bandset that succeed it will be automatically repositioned without any intervention or calculation required by the developer or the xApp.

Second, bandsets may be bound to databases in a natural, visual, and intuitive manner. If a band is bound to a data source, then the layout, presentation, and logic need only to be defined once at design-time without any need to know or consider how many records are in the associated data source. Then, at run-time the band is displayed repeatedly for as many records as defined at design-time or run-time.

Third, bands within a data-bound bandset can be displayed in a sorted and/or grouped fashion. These bands may be sorted or grouped in a manner very similar to “Sorting” and “Grouping” functions in Microsoft Access Reports.

The following is a more detailed description of bands, bandsets, and forms. A form is a construct that contains two layers, namely, a logical layer and a presentation layer. A form is also typically linked to a third layer, namely, the data layer, which is a connection to a database.

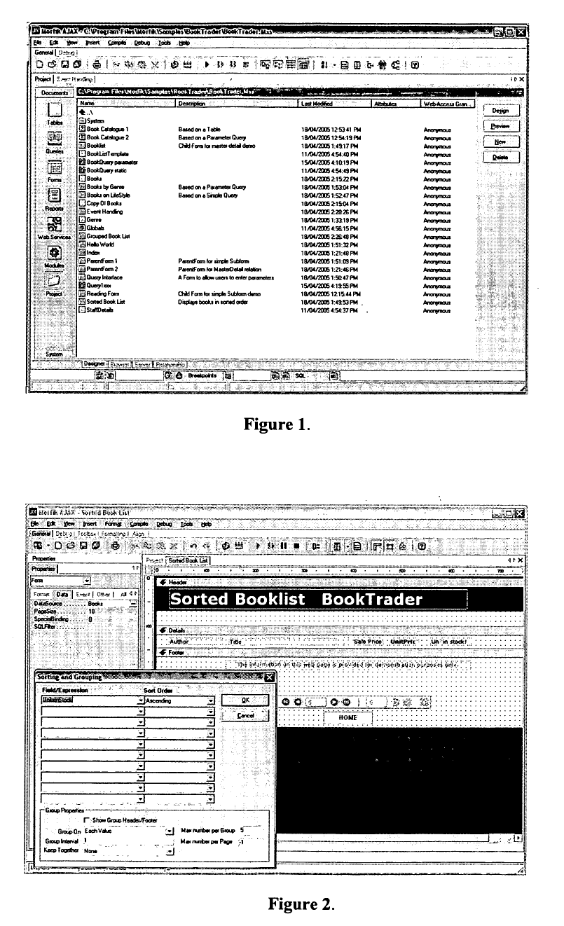

At design-time, the developer may create a form to define a template or initial configuration of the controls within a band. See FIGS. 2, 4, 9, 10, and 12. In accordance with a preferred embodiment of the system and method of the present invention, the positions and formatting of the controls can also be easily altered at run-time.

FIG. 2 shows a set of a sorted database-driven bands at design-time. Note that one of the properties that can be set via the Property Sheet (often called Object Inspector) is the “PageSize” (i.e., the number of bands in the bandset), which, for example, has been set to 10, indicating that the records are grouped and viewed 10 at a time. FIG. 4 shows a grouped set of database-driven bands at design-time and illustrates that a bandset is capable of grouping records in a manner akin to standard reporting applications such as Microsoft Access or Crystal Reports. Note that one may limit the number of records per group (for example, in this case 5). FIG. 4 shows the form at design-time.

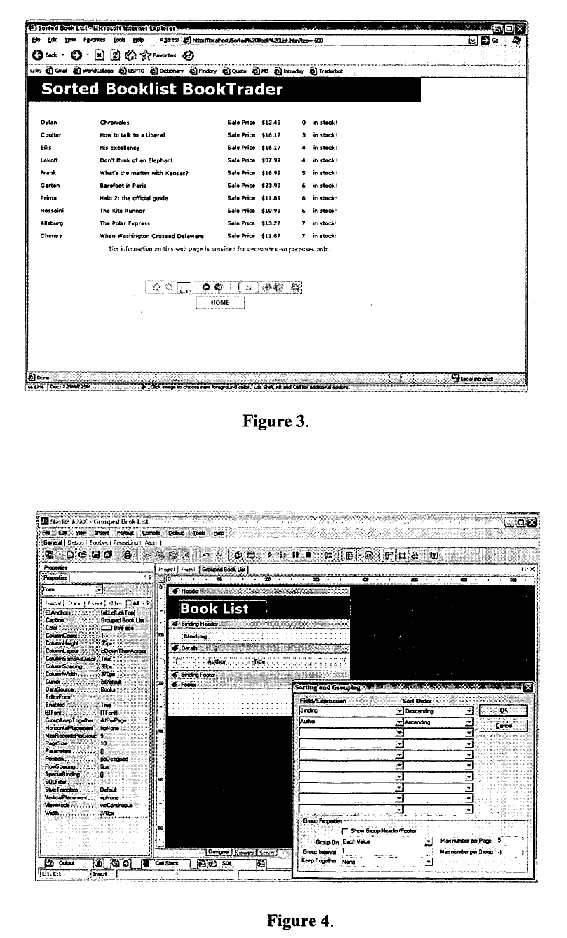

At run-time, the various embodiments of the system and method in accordance with the present invention display this configuration multiple times, once for each record of its data source, each occurrence representing a different band. See FIGS. 3, 5, 6, and 13. For a form that is not connected to a data source, the associated bandset consists of a single band.

FIG. 3 shows a sorted set of database-driven bands at run-time. Note that the first 10 records are displayed in ascending order of “UnitsInStock,” as intended. The user can navigate to the next set of 10 records using the navigator bar.

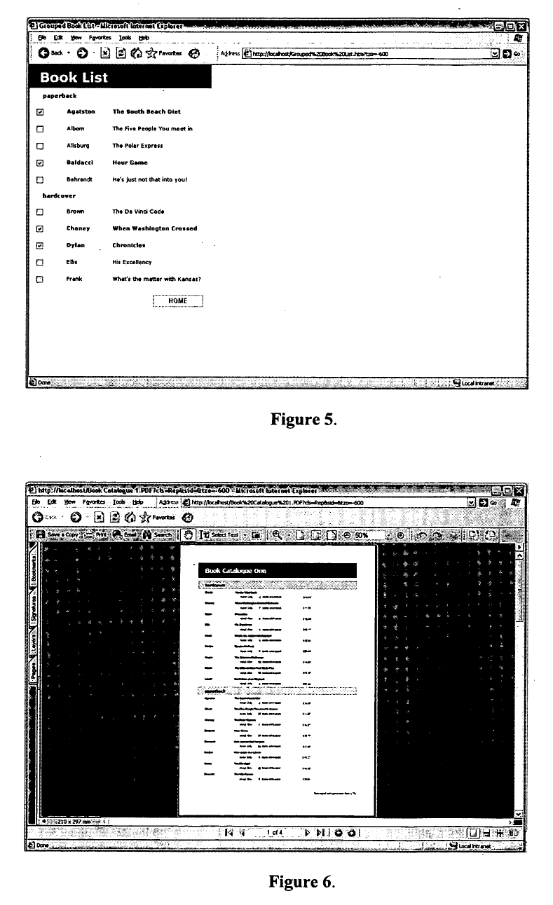

FIG. 5 shows a grouped set of database-driven bands at run-time. In the illustrated example, the xApp groups all the books first according to whether they are paperback or hardcover, and then according to “Author.” Note that only the first five records per group are displayed, as desired.

FIG. 6 illustrates PDF reports implemented via bandsets at run-time. At design-time, time, the methodology is virtually identical to design of a web-based form (not shown). Note that apart from the format (PDF instead of DHTML), the form exhibits all the features of the other embodiments, as shown in FIG. 5 for example.

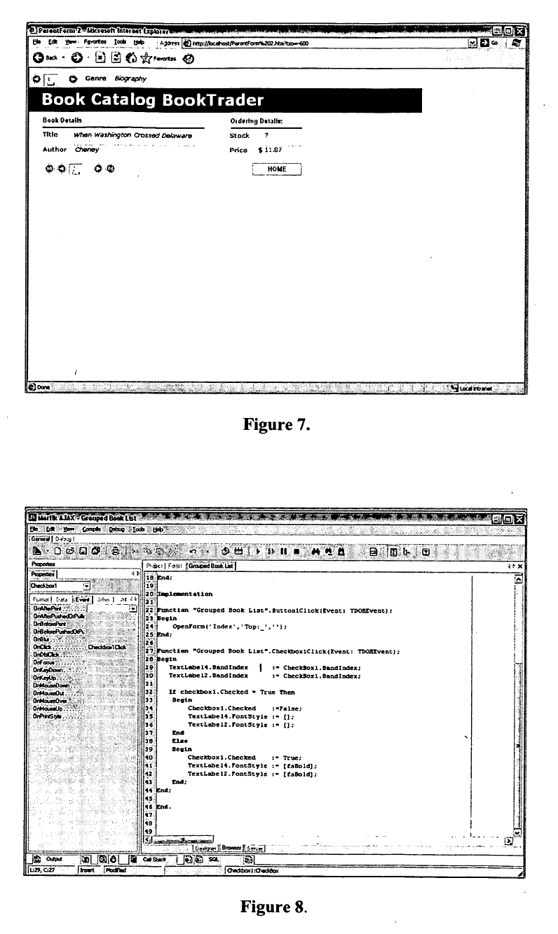

FIG. 7 illustrates single-view screens implemented via bandsets. In the embodiment shown in FIG. 7, the data for the bandset is bound to the form in the browser. When the user navigates to a different record, nothing on the page is refreshed on the page, except the data-driven text associated with the “Title,” “Author,” “Stock,” and “Price.” That is, not even the heading captions are refreshed. In this mode, a PageSize (i.e., the size of the bandset) of 10 means that the browser will cache and retrieve 10 records from the server at a time. Navigating within this set of 10 records will then be nearly instantaneous, as communication between the browser and the server is not required. This set of repeated bands constitutes the presentation layer of a bandset. In the phrase “hierarchy of heterogeneous nodes,” each parent node is a bandset, and each leaf node is a standard control such as a TextLabel, CheckBox, RadioButton, Image Control, etc., but not including the specialized subform control.

One currently preferred embodiment of the system and method in accordance with the present invention optionally has two additional specialized bands associated with each bandset, namely, a header band and a footer band. Architecturally, these bands are identical to the main details and, except that unlike the main band which repeats for each record, the header and footer bands are only displayed once. See FIGS. 2-7, 9-11 and 13. In these examples, the headers and footers are used to display headings, navigation bars, and supplementary material.

FIG. 8 illustrates event-handling in a repeatable band. Programming events does not require the continual use of identifiers, nor does the xApp duplicate the logical layer for every instance of each control.

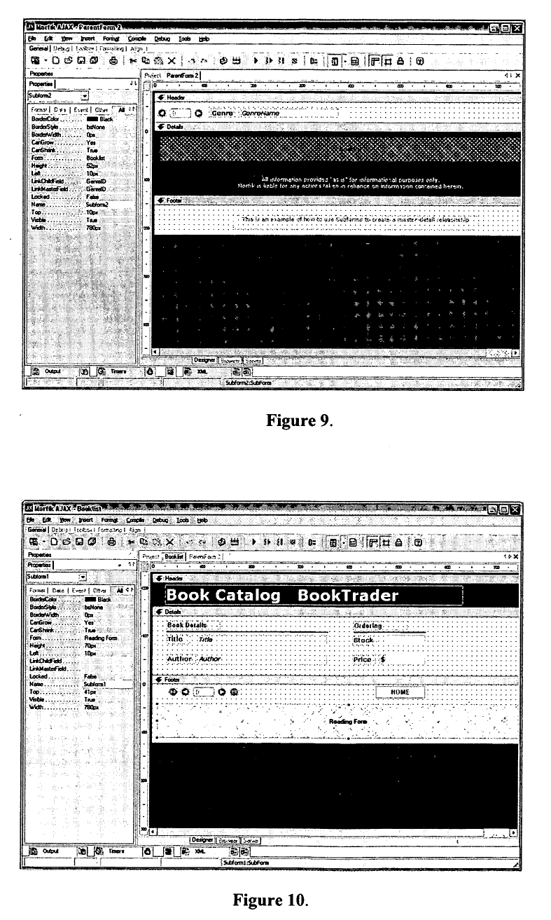

FIG. 9 illustrates using subforms to define spatial regions and child nodes for other forms at design-time. As shown in FIG. 9, “Parent Form 2” contains a subform in the main details band. The developer may set at design-time or at run-time what form shall appear in this subform. In the illustrated example, the form “Booklist” is set to appear in this spatial region.

One of the pivotal aspects of the various embodiments of the system and method in accordance with the present invention is the ability to display multiple occurrences of each form control using a single object. See FIGS. 5, 8, 10, 11, and 13. This is in contrast to current object-based or object-oriented visual design paradigms that require creating new objects for each occurrence of a control, each with its own logical layer (event handling, etc.). The logical layer includes the in-built functionality of the control, as well as any additional user-defined logic. This methodology inevitably leads to an unnecessary and certainly undesirable proliferation of objects, which then results in an excessive burden on the processing and memory management of the browser, especially if these objects contain non-trivial logical layers.

Considered in more detail, FIG. 10 illustrates hierarchical nodes via nested subforms at design-time. The form “BookList” also contains a subform in the footer band. Note that the size of this form is larger than the size of its enclosing subform. See FIG. 9.

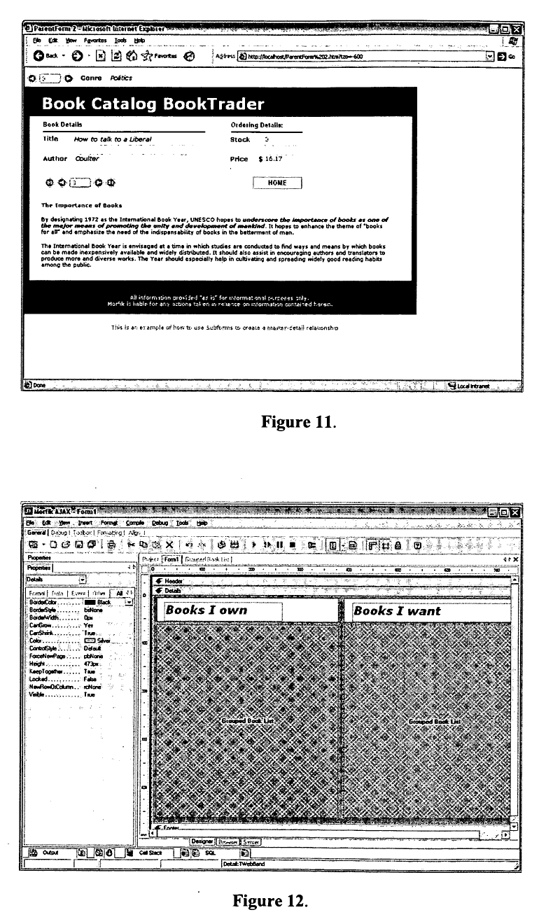

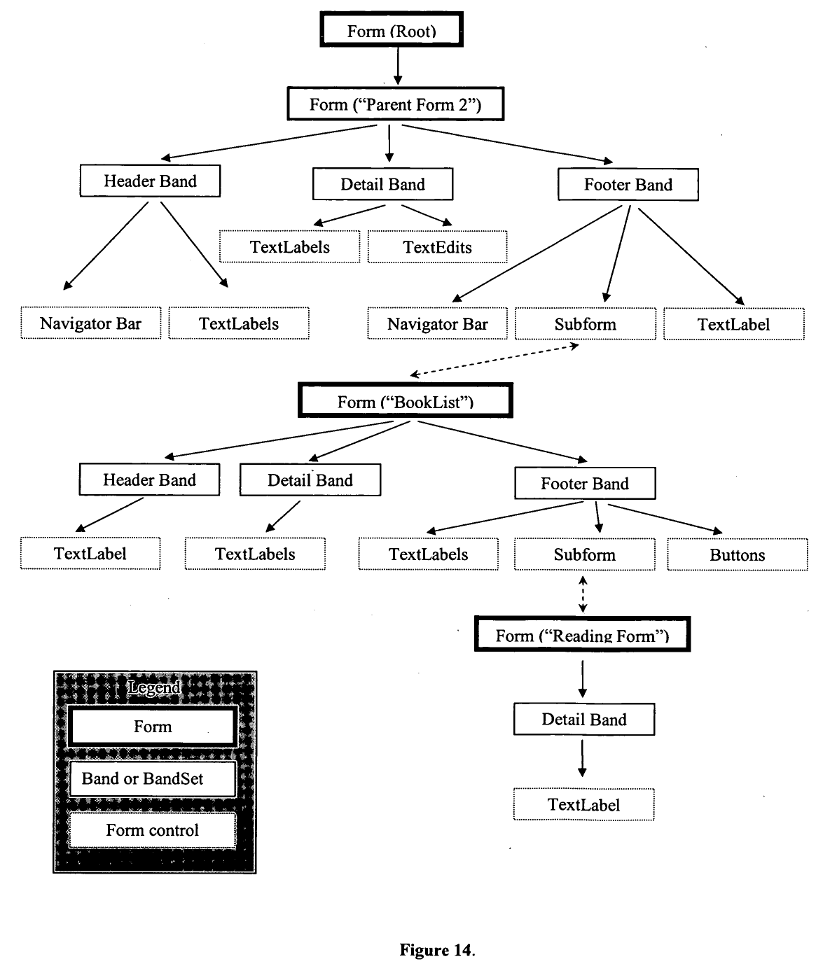

FIG. 11 illustrates hierarchical nodes via nested subforms at run-time. Note that both subforms have grown to accommodate the content of their corresponding forms. A diagram illustrating the hierarchy of heterogeneous nodes for this form is shown in FIG. 14.

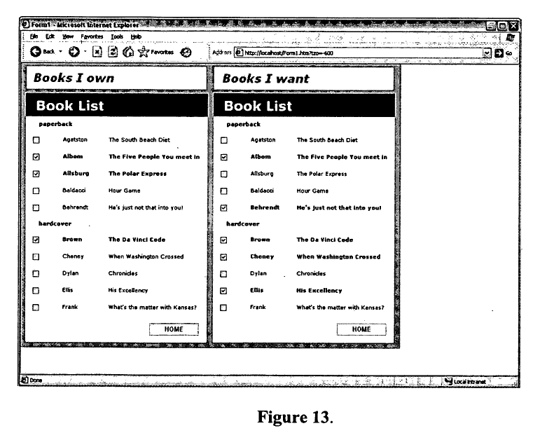

FIG. 13 illustrates displaying multiple instances of the same form simultaneously at run-time. If the user selects a check box in the left-hand form, then it will only highlight the author and title in the left form, and likewise for the right-hand form. The underlying code does not have to be altered (see FIG. 8) in order for this to correctly work with two simultaneous instances of the same form.

The logical layer of a form in accordance with the various embodiments of the system and method of the present invention contains all necessary logical infrastructure, as well as all of the user-defined business logic specific to that form. The logical layer has both a browser-side component, which acts in a similar way to an Ajax engine, as well as a server-side component. One of the differences between the browser-side logical layer and virtually all Ajax applications is that with Ajax applications, the entire Ajax engine is downloaded from the server to the browser at the first moment the user visits the web site. In accordance with the various embodiments of the system and method of the present invention, core modules of the engine are downloaded on the initial visit, but the application specific components of the browser-based engine are downloaded per demand as the user visits various parts of the xApp. The logic associated with these application components is incrementally added to the main and existing browser-based engine, which is stored in the logical layer of the top-most node. In one currently preferred embodiment of the system and method of the present invention, a special form that does not contain a presentation or data layer is automatically set as the top-most (root) node from which all other forms that the developer defines descend. See FIG. 14. FIG. 14 is a diagram illustrating the hierarchy of the xApp described in conjunction with the embodiment shown in FIGS. 9, 10, and 11.

The presentation layer of a bandset is preferably implemented as an HTML table, and a band as a cell within the table. In this manner, the bands can either be displayed one below the other (one cell per row) or occur in a multi-columned manner either going in an across-then-down or down-then-across layout.

Furthermore, the forms and their related entities such as queries and tables in one currently preferred embodiment of the system and method of the present invention are created in an integrated visual design environment similar to Microsoft Access or Borland Delphi. Consequently, the developer is not required to know any SQL or scripting language.

As briefly described earlier, there are modular and hierarchical components associated with the various embodiments of the system and method in accordance with the present invention. The system and method in accordance with various embodiments of the present invention include a specialized web component (control) referred to as a “subform.” This defines, within the parent form, a spatial region and a hierarchical position of another form. In one currently preferred embodiment of the system and method in accordance with the present invention, a subform is implemented via a Division (DIV) element, which is a standard HTML element. In accordance with one contemplated alternative embodiment, the form may be implemented as an inline frame (iframe).

Subforms used in accordance with the various embodiments of the system and method of the present invention, which may be nested to an arbitrary level, are in contrast to Microsoft Access subforms that can only be nested to a maximum of three levels deep. Further, subforms have the distinguishing capability to expand (or shrink) based on the contained content. Furthermore, this capability can have an automatic cascading effect. That is, if a subform expands, then the form that contains it may also expand to accommodate the enlarged subform, and if that form is also contained in a subform, then its parent form may also enlarge, and so on. See FIGS. 9, 10, and 11.

The choice of which form appears in a particular subform may be selected at design-time and/or run-time, and further the form may be altered at anytime during run-time based on business logic or user interaction. A consequence of the self-similar nature of the xApp at design-time is that the developer can build a total solution in a modular manner where each module exhibits significant similarities (in this case, they are all forms). At run-time, the self-similar nature enables the developer to use a portion of the xApp, and it will still be capable of existing as a fully-workable web solution that can be natively interpreted by browsers. For example, FIG. 5 is a portion of FIG. 12, and yet is a fully self-contained web solution. FIG. 12 illustrates displaying multiple instances of the same form simultaneously at design-time, that is, “Form1” contains two subforms, each of which is set to display the form “Grouped Book List.”

In accordance with the various embodiments of the system and method of the present invention, the entire design methodology of a web site pivots around the use of subforms and the ability to interact with them. From a layout perspective, the rectangular spatial region that defines the viewing area of the web site is partitioned via subforms, each partition representing a different node. Then each of these spatial regions, which defines the viewing area of different nodes, is further partitioned to define the spatial region of child nodes. In this manner, the web site is a hierarchy of spatially connected heterogeneous nodes where each parent node is a bandset and each leaf of the hierarchical tree is a control (for example, see FIG. 14), except possibly in degenerate cases such as a bandset that does not contain any controls at all.

One will note that this abstract hierarchy, which describes the spatial relationship between each of the nodes, is at the topological level and is therefore independent of the actual size of each node's physical representations. In other words, if a mechanism exists that allows a bandset to increase in size due to accommodating more content and/or records, then this may affect the positions and/or sizes of other bandsets, but it will not affect in any way the hierarchical or topological structure or nature of the web site.

Additionally, the system and method in accordance with the various embodiments of the present invention are characterized by scalability and security through nested xApps. One of the key features of the system and method of the present invention is the ability to nest an xApp within another xApp in a manner that their contents are spatially and computationally related. Accordingly, solutions that are developed through the use of the system and method in accordance with the present invention are highly scalable. This aspect of the system and method of the present invention makes it possible to build a complex xApp through combining elemental xApps that are of a lesser degree of complexity.

The same aspect of the system and method in accordance with the various embodiments of the present invention also provides a mechanism to selectively secure portions of the xApp. This is achieved by including the sensitive portions that require a higher level of security in an embedded xApp that runs on the Secure Socket Layer (SSL) protocol.

Insofar as the run-time process is concerned, the hierarchical structure of the xApp offers many distinct advantages over traditional models of web site design and architecture. The three main advantages are as follows. First, session state management is inherently kept within the browser as its context always remains live. Second, precise and intuitive methods of accessing or altering each and every node from within the logic component of any part of the web site are available. Third, incremental changes of the xApp may be effected through on-demand generation of arbitrary nodes at run-time. Although some current technologies may have some of these features to a limited degree, none of them has all of these features that function in a holistic manner, which is what is required for a full hierarchical implementation.

In accordance with the various embodiments of the system and method of the present invention, browser context remains through the mechanism of computationally related nodes. Session state management is addressed by maintaining the entire session state in the logical layer of the top spatial node. In many current approaches described above that maintain session state in the client tier, the client merely stores a session ID which is then referred to the server for more detailed session state management. There are also approaches that maintain a set of state variables that are maintained within a page and retrieved every time the page is posted back to the server for further processing. In one currently preferred embodiment of the system and method in accordance with the present invention, the client tier is responsible for the complete session state management and utilizes a fully stateless server. The only contemplated exception is if the web site has a login page, then a session ID is kept on the server and each request from the browser to the server is authenticated using this session ID. Since every portion of the xApp is a descendant of the top node, as shown in FIG. 14, irrespective of the manner in which the user traverses the xApp, the session state is directly accessible and fully managed without recourse to any browser-server return trips.

Various distinguishing features of the system and method in accordance with the present invention will now be described with reference to FIG. 13 which illustrates how accessing and altering arbitrary nodes of the hierarchy are typically achieved. In the following description, unless otherwise stated, all code is to demonstrate the semantic nature of the programming used in accordance with the system and method of the present invention. All syntactical variants are implicitly included in contemplated alternative embodiments, whether they are in an object-oriented, object-based, or even scripting language. In one currently preferred embodiment of the system and method in accordance with the present invention, the developer can program in either an object-oriented Pascal or Visual Basic variant.

FIG. 12 displays a web solution that consists of two instances of the same construct. Each construct is a list of books that is grouped first according to whether or not the book is a paperback, and then alphabetically according to author. If the user clicks any of the check boxes, then the box will become checked, and the corresponding book's author and title will become bold. If the user clicks again, the box will become unchecked, and the book's author and title will revert to normal.

The form to display each construct has been earlier described in conjunction with FIG. 4. The code for the CheckBox1Click function maybe implemented as:

Function Form1.CheckBox1Click(Event: TDOMEvent);
Begin

| | |
|---|---|
| Label1.BandIndex | := CheckBox1.BandIndex; |

// Notice that from here on there is no need

```
  for any form of identifier for either the Label
  or the CheckBox!
```

If CheckBox1.Checked = True Then
Begin

| | |
|---|---|
| CheckBox1.Checked | := False; |
| TextLabelAuthor.FontStyle | := [ ]; |
| TextLabelTitle.FontStyle | := [ ]; |

End
Else
Begin

| | |
|---|---|
| CheckBox1.Checked | := True; |
| TextLabelAuthor.FontStyle | := [fsBold]; |
| TextLabelTitle.FontStyle | := [fsBold]; |

End;

End;

This shows that a developer can access and alter a particular node in a manner that is independent of many instances of that particular control and provides developers with an intuitive and yet sophisticated method of attributing multiple controls to the same event.

The foregoing description illustrates that the developer can access and alter the nodes of an xApp at a much higher level of abstraction than directly altering the DOM. Further, it shows that the developer can access and alter a control independent of how many instances of the particular control are currently being displayed, irrespective of whether there are multiple instances of a control, because it is part of a repeatable band or multiple instances of the form exist (which may occur either if the form is displayed within a subform of a repeatable band, or if the developer specifically invokes a second instance of the form).

To programmatically alter a web component, for example, a checkbox, in the third band/record, without waiting for or requiring user interaction, is straightforward. If the code is written in the logical layer of Form1, then the code is simply:

| | |
|---|---|
| Checkbox1.BandIndex | := 3; |
| Checkbox1.CheckBox | := False; |

If the developer is writing code in the logical layer of a different form, then, in one currently preferred embodiment of system and method in accordance with the present invention, the developer needs to use the syntax:

“Form1”(xApp.Forms[‘Form1’]).Checkbox1.BandIndex
:= 3;

The first portion, “Form1” (•) is purely for typecasting, because the language used to program is strongly typed object-oriented language and therefore requires the user to typecast all objects.

The concept and holistic implementation of band indexes allows the developer to easily identify particular instances of repeated controls and programmatically alter/update them in an incremental way. This provides developers with a robust methodology for creating sophisticated web solutions by combining numerous simple modules together, each with their own presentation, logical, and data layer.

In general, any web page or part thereof that is not created instantly is created incrementally. However, of more significant concern is not whether something is incrementally created, but whether it has the ability to perform on-demand incremental updates or changes. In this manner, an incremental change refers to the process by which something that has already been created is altered in a manner that does not require the resulting object to be re-created in its entirety, whether it be an xApp, an Ajax engine, a Flash control, or a web page, etc.

The ability for web solutions to incrementally change on-demand had its genesis in framesets. In that case, if a web page was a composite of multiple web pages via framesets, then each of the frames could be incrementally changed on demand. With the advent of iframes as well as the Ajax movement, the smoothness of this functionality was significantly enhanced. However, the underlying server architecture and processes remained relatively unchanged. In all these cases, the newly updated parts of the web site are actually other web pages that existed at design-time, and, therefore, prior to the request, even though they may get parsed by the server for special tags which insert customized code and/or content into the page. That is, an incremental update simply consists of replacing a current web page that is viewed via a frame or iframe with another web page. In this respect, the server is simply a repository of pre-existing web pages with a mechanism that fetches and parses them in a structured and predefined manner.

In contrast, in accordance with various embodiments of the system and method of the present invention, web pages are not stored on the server. Each request to the server creates an HTML snippet from scratch at run-time based on a form which is then sent back to the browser, incorporated into the browser's DOM, and displayed in the appropriate spatial region. That is, the system and method of the present invention provide on-demand (at run-time) incremental updating of the xApp through the generation and alteration of arbitrary nodes.

Considered in more detail, in accordance with the various embodiments of the system and method of the present invention, all the forms are available to the developer in a flat-filed system whose hierarchical structure is stored invisibly in the logical layer of the top node. Altering a portion of the xApp is simply a matter of opening a new form within the subform in another (parent) form. For example, suppose that “Form1” contains a subform called “Subform1.” Suppose further that from within the logical layer of “Form4” one wants to invoke a command that opens another form, for example, “Form2”within the region defined by “Subform1,” which is located in “Form1.” In this case, the syntax is simply:
OpenForm(Form2, Form1:Subform1,″)

If “Form1” is not currently open and viewable, then this syntax will return an error message. In the case in which the developer specifically wants to label multiple instances, called, for example, “MyFirstForm2”and “MySecondForm2,” of the same class of a form (“Form2”), one can use the following extended syntax:

| | |
|---|---|
| OpenForm(MyFirstForm2:Form2, | Form1:Subform1,'') |
| OpenForm(MySecondForm2:Form2, | Form1:Subform1,'') |

Unlike the previously cited Javascript window syntax, which required listing all the intermediary nodes as one traversed the hierarchical tree, the various embodiments of the system and method in accordance with the present invention eliminate this complication and provide the developer with a syntax whose result is independent of the spatial or hierarchical position of the involved nodes. That is, the syntax is independent of where the bandsets associated with “Form1,” “Form2,” or “Form3” exist in the hierarchy of nodes, as this command will have the same effect.

Typically, when the OpenForm command is invoked, it creates a node that represents the desired form, for example, “Form2,” that is to be displayed in the subform of a parent form. In one currently preferred embodiment of the system and method in accordance with the present invention, if the OpenForm command is invoked again to open a different Form, for example, “Form3,” in the same subform, then instead of destroying the first node and replacing it with a new one, it simply renders the first one inactive (and invisible). This methodology has the advantage that if the developer wants to re-open “Form2” in the subform, the system and method in accordance with the present invention do not need to re-create it, but rather only need to make it active again and render all other forms for that subform inactive.

Also, one embodiment of the system and method in accordance with the present invention optionally allows the developer at run-time to open and display a form within another parent form, without requiring the developer to insert a subform control in the parent form at design-time. An example of when this may be useful is when the developer wants to display a form that represents an area or frame akin to a dialog box, which although not an intrinsic or permanent part of the modular design of the web solution, is a necessary part of the user-interface.

While the foregoing description has been with reference to particular embodiments of the present invention, it will be appreciated by those skilled in the art that changes to these embodiments may be made without departing from the principles and spirit of the invention. Accordingly, the scope of the present invention can only be ascertained with reference to the appended claims.

What is claimed is:

1. A method for programming a web site or web application, comprising:
creating a web solution that eliminates the page refresh limitation at the architectural level, thereby allowing the solution to run more like desktop applications, by modeling the web solution on a topological map that consists of a hierarchy of heterogeneous nodes, each of which is spatially and computationally related, and is maintained both at design-time and run-time, wherein the hierarchical nodes represent individual, dynamic, and interactive components that run natively in a web browser, are generated incrementally, independently, and on-demand and comprise a single entity whose context persists throughout the entire user's session and whose layout, presentation, logic, and content only partially or incrementally change at run-time in response to a user's inputs and interactions.

2. The method of claim 1, further comprising designing the web solution in a fully modularized fashion.

3. The method of claim 1 wherein the architecture based on the topological map that consists of a hierarchy of heterogeneous nodes which are spatially and computationally related at design-time, as well as run-time, comprises parent nodes that all exhibit a self-similar structure.

4. The method of claim 3 wherein the parent nodes are all created from an identical construct and contribute to the web site or web application's fractal or self-similar nature.

5. The method of claim 3, further comprising designing the web solution in a fully modularized fashion via a Visual Programming Environment whose hierarchy at design-time is fully maintained at run-time.

6. The method of claim 1 wherein a user interacts with the solution output through the programming logic that is stored, accesses, and alters through the browser's Document Object Model.

7. The method of claim 1 wherein the method is characterized by scalability through the ability to nest one solution within another solution in a manner that their contents are spatially and computationally related and thus to build a complex solution through combining elemental solutions that are of a lesser degree of complexity.

8. The method of claim 1, further comprising selectively securing portions of the solution by including the sensitive portions that require a higher level of security in an embedded solution that runs on a Secure Socket Layer (SSL) protocol.

9. A system for programming a web site or web application, comprising:
means for creating a web solution that eliminates the page refresh limitation at the architectural level, whereby the solution runs more like desktop applications, by modeling the web solution on a topological map that consists of a hierarchy of heterogeneous nodes, each of which is spatially and computationally related, and is maintained both at design-time and run-time, wherein the hierarchical nodes represent individual, dynamic, and interactive components that run natively in a web browser, are generated incrementally, independently, and on-demand and comprise a single entity whose context persists throughout the entire user's session and whose layout, presentation, logic, and content only partially or incrementally change at run-time in response to a user's inputs and interactions.

10. The system of claim 9, further comprising means for designing the web solution in a fully modularized fashion.

11. The system of claim 9 wherein the architecture based on the topological map that consists of a hierarchy of heterogeneous nodes which are spatially and computationally related at design-time, as well as run-time, comprises parent nodes that all exhibit a self-similar structure.

12. The system of claim 11 wherein the parent nodes are all created from an identical construct and contribute to the web site or web application's fractal or self-similar nature.

13. The system of claim 11, further comprising means for designing the web solution in a fully modularized fashion via a Visual Programming Environment whose hierarchy at design-time is fully maintained at run-time.

14. The system of claim 9 wherein a user interacts with the solution output through the programming logic that is stored, accesses, and alters through the browser's Document Object Model.

15. The system of claim 9 wherein the system is characterized by scalability through the ability to nest one solution within another solution in a manner that their contents are spatially and computationally related and thus to build a complex solution through combining elemental solutions that are of a lesser degree of complexity.

16. The system of claim 9, further comprising means for selectively securing portions of the solution by including the sensitive portions that require a higher level of security in an embedded solution that runs on a Secure Socket Layer (SSL) protocol.
